(19) United States
(12) Patent Application Publication
(10) Pub. No.: US 2016/0360450 A1
(43) Pub. Date: Dec. 8, 2016

(54) MODIFYING PERIODIC UPLINK TRANSMISSIONS TO MITIGATE LOSS OF INFORMATION TRANSMITTED DURING TUNE AWAY PERIOD

(71) Applicant: QUALCOMM Incorporated, San Diego, CA (US)

(72) Inventors: Ming YANG, San Diego, CA (US); Qingxin CHEN, Del Mar, CA (US); Tom CHIN, San Diego, CA (US)

(21) Appl. No.: 14/733,939

(22) Filed: Jun. 8, 2015

(51) Int. Cl. H04W 36/00

(52) U.S. Cl. CPC H04W 36/0066; H04W 36/14

(57) ABSTRACT

A method of wireless communication includes determining when a tune away from a serving RAT to a non-serving RAT occurs. The method also includes determining whether to suspend one or more periodic uplink transmission before the tune away based on a serving cell signal quality, a specified quality of service, and/or timing of an uplink transmission in relation to the tune away.

### BACKGROUND

### Field

Aspects of the present disclosure relate generally to wireless communication systems, and more particularly to suspending periodic uplink transmissions to mitigate loss of critical information transmitted during a tune away period.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In one aspect of the present disclosure, a method of wireless communication is disclosed. The method includes determining when a tune away from a serving radio access technology (RAT) to a non-serving RAT occurs. The method also includes determining whether to suspend one or more periodic uplink transmission before the tune away based on a serving cell signal quality, a specified quality of service, and/or timing of an uplink transmission in relation to the tune away.

Another aspect of the present disclosure is directed to an apparatus including means for determining when a tune away from a serving RAT to a non-serving RAT occurs. The apparatus also includes means for determining whether to suspend at least one periodic uplink transmission before the tune away based on a serving cell signal quality, a specified quality of service, and/or timing of an uplink transmission in relation to the tune away.

In another aspect of the present disclosure, a computer program product for wireless communications in a wireless network is disclosed. The computer program product has a non-transitory computer-readable medium with non-transitory program code recorded thereon. The program code is executed by a processor and includes program code to determine when a tune away from a serving RAT to a non-serving RAT occurs. The program code also includes program code to determine whether to suspend one or more periodic uplink transmission before the tune away based on a serving cell signal quality, a specified quality of service, and/or timing of an uplink transmission in relation to the tune away.

Another aspect of the present disclosure is directed to an apparatus for wireless communication having a memory (e.g., memory module) and at least one processor (e.g. coupled to the memory. The processor(s) is configured to determine when a tune away from a serving RAT to a non-serving RAT occurs. The processor(s) is also configured to determine whether to suspend one or more periodic uplink transmission before the tune away based on a serving cell signal quality, a specified quality of service, and/or timing of an uplink transmission in relation to the tune away.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downlink frame structure in LTE.

FIG. 4 is a diagram illustrating an example of an uplink frame structure in LTE.

FIG. 5 is a diagram illustrating an example of a radio protocol architecture for the user and control plane.

FIG. 6 is a block diagram conceptually illustrating an example of a telecommunications system.

FIG. 7 is a block diagram conceptually illustrating an example of a frame structure in a telecommunications system.

FIG. 8 is a diagram illustrating an example of a base station and user equipment in an access network.

FIGS. 9, 10A, 10B, 11, and 12 illustrate examples of timelines for communications between a UE and a base station according to aspects of the present disclosure.

FIG. 13 is a block diagram illustrating a method for suspending uplink transmissions according to an aspect of the present disclosure.

FIG. 14 is a block diagram illustrating different modules/means/components in an exemplary apparatus.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

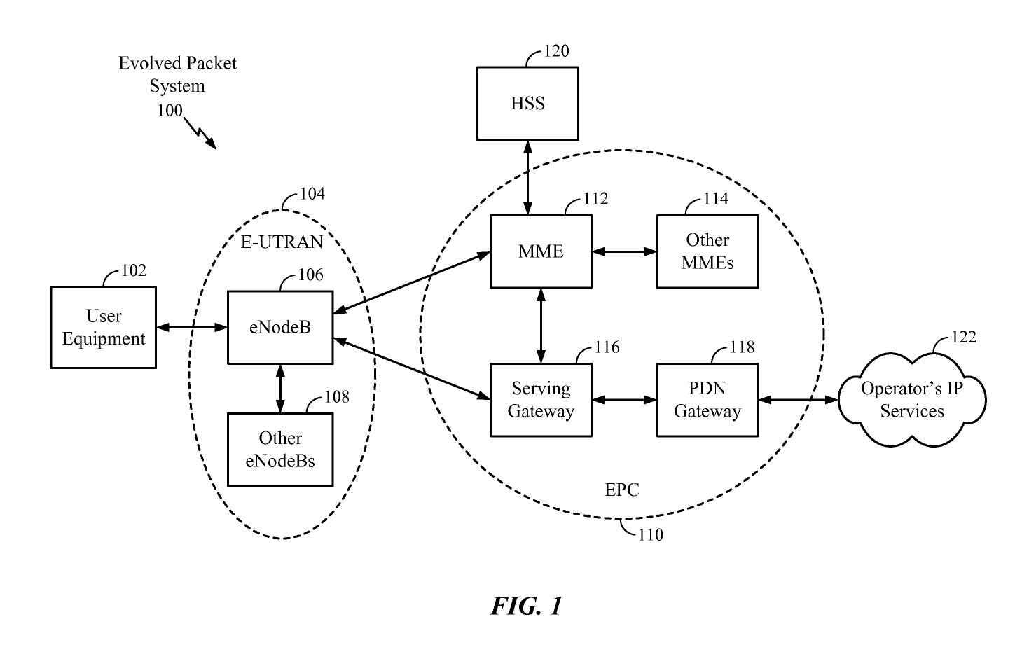

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an 51 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

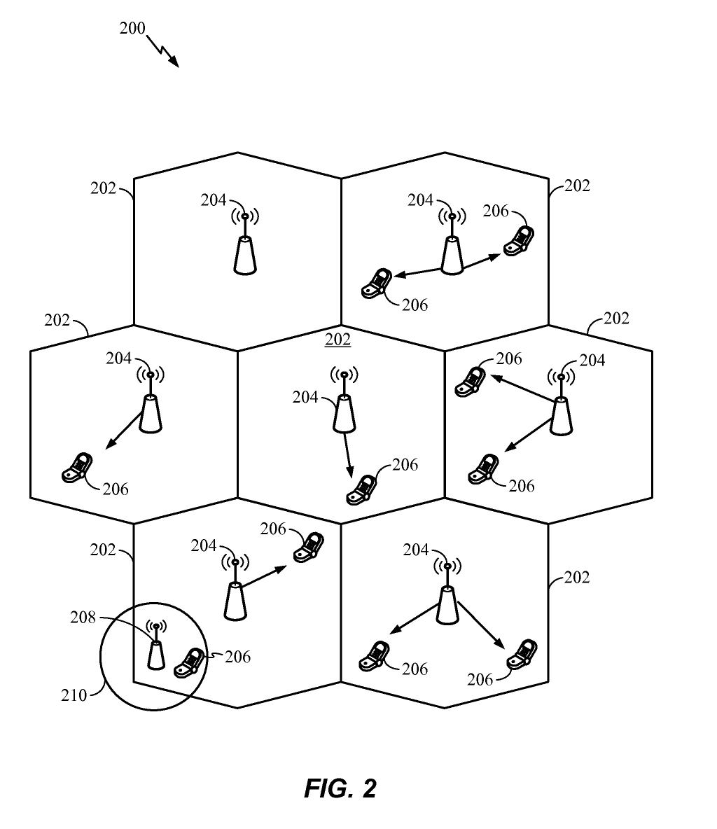

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. A lower power class eNodeB 208 may be a remote radio head (RRH), a femto cell (e.g., home eNodeB (HeNB)), a pico cell, or a micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, orthogonal frequency-division multiplexing (OFDM) is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to evolution-data optimized (EV-DO) or ultra mobile broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to universal terrestrial radio access (UTRA) employing wideband-CDMA (W-CDMA) and other variants of CDMA, such as TD-SCDMA; global system for mobile communications (GSM) employing TDMA; and evolved UTRA (E-UTRA), ultra mobile broadband (UMB), IEEE 802.11 (Wi-Fi), IEEE 802.16 (WiMAX), IEEE 802.20, and flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a discrete Fourier transform-spread (DFT-spread) OFDM signal to compensate for high peak-to-average power ratio (PAPR).

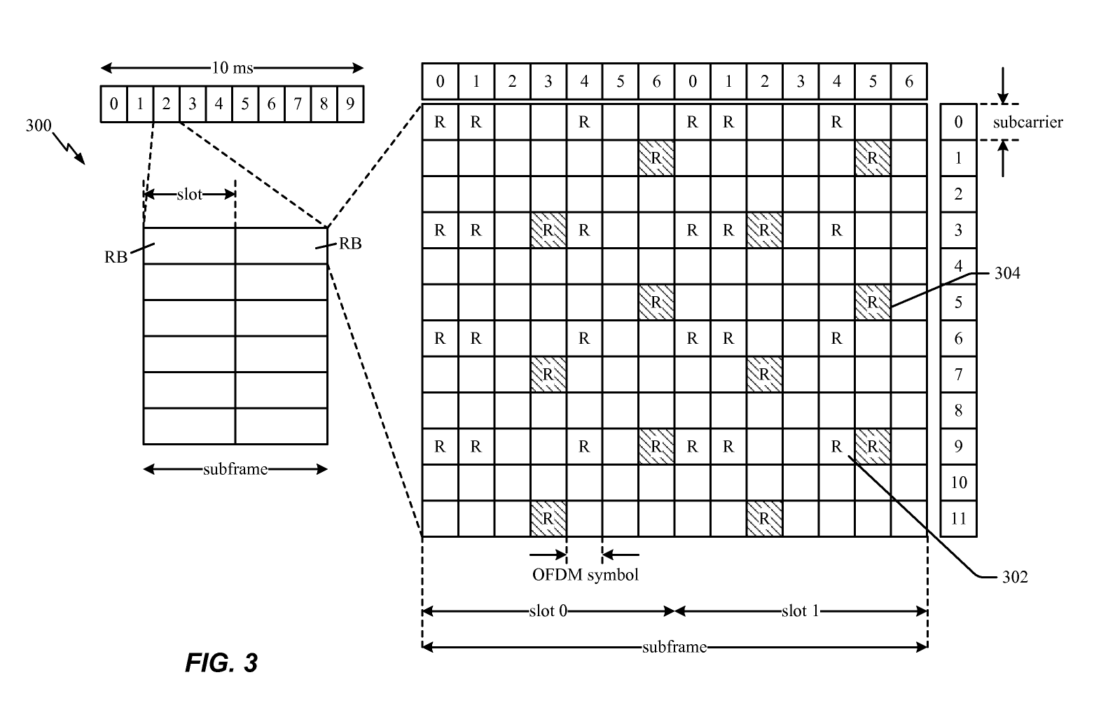

FIG. 3 is a diagram 300 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, for a total of 84 resource elements. For an extended cyclic prefix, a resource block contains 6 consecutive OFDM symbols in the time domain, resulting in 72 resource elements. Some of the resource elements, as indicated as R 302, 304, include downlink reference signals (DL-RS). The DL-RS include cell-specific RS (CRS) (also sometimes called common RS) 302 and UE-specific RS (UE-RS) 304. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

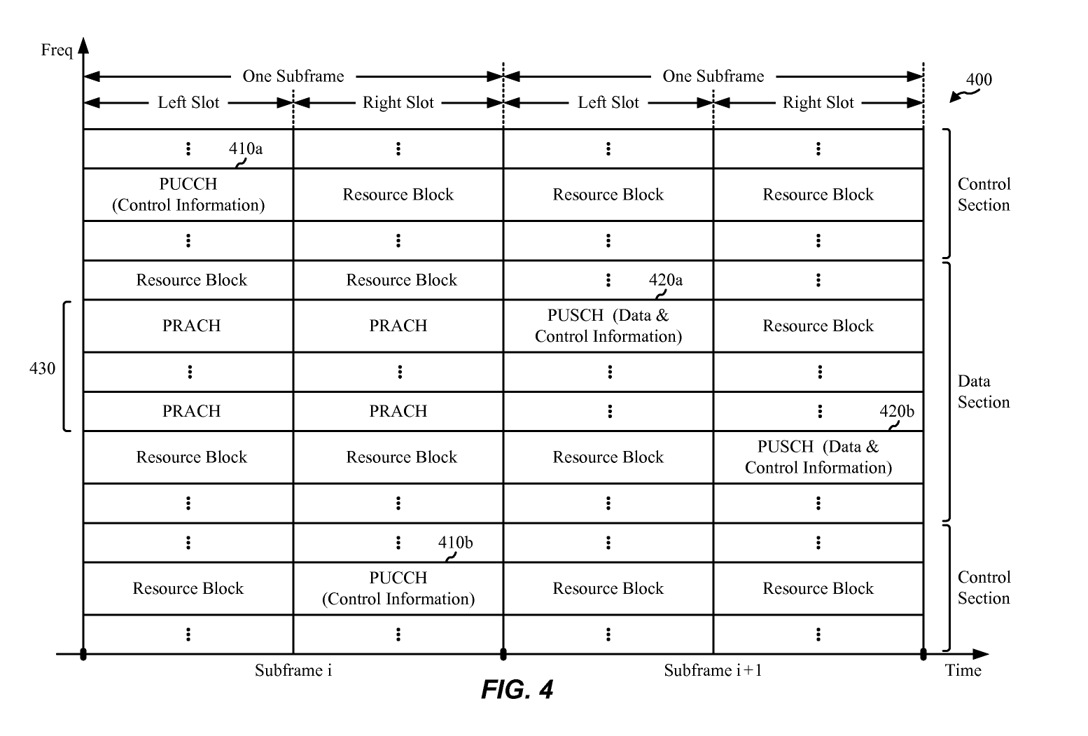

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

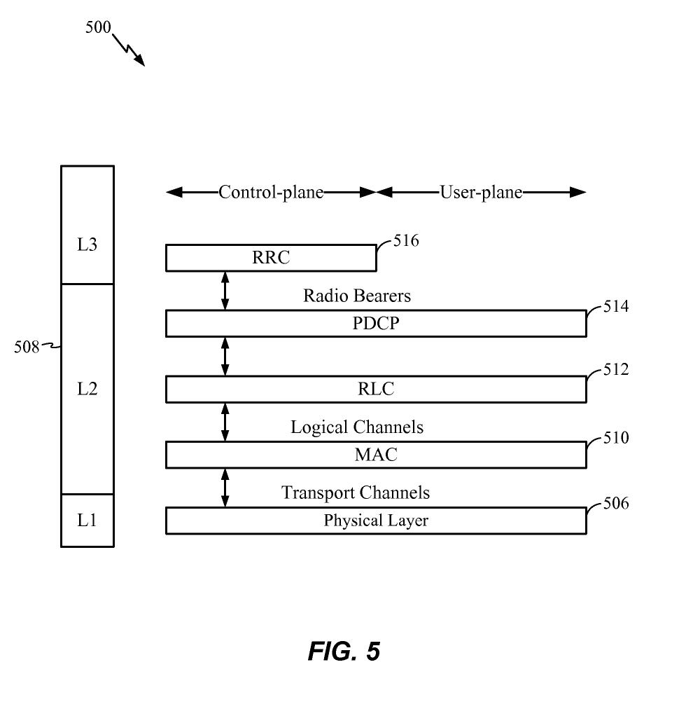

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNodeB and the UE.

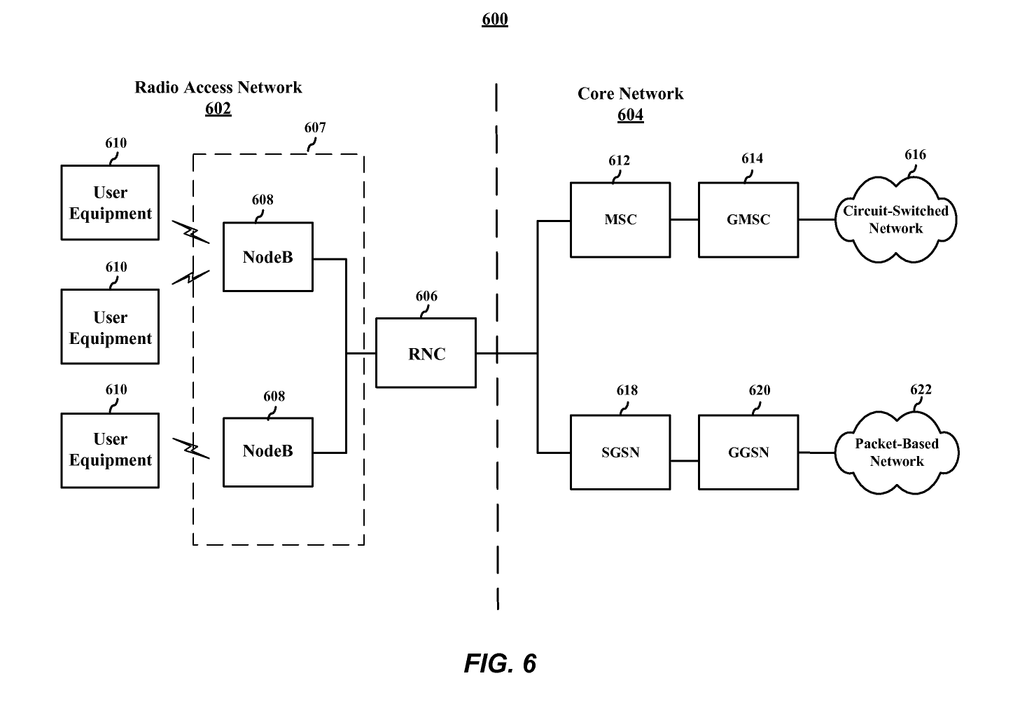

Turning now to FIG. 6, a block diagram is shown illustrating an example of a telecommunications system 600. The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system employing a TD-SCDMA standard. In this example, the UMTS system includes a radio access network (RAN) 602 (e.g., UTRAN) that provides various wireless services including telephony, video, data, messaging, broadcasts, and/or other services. The RAN 602 may be divided into a number of radio network subsystems (RNSs) such as an RNS 607, each controlled by a radio network controller (RNC) such as an RNC 606. For clarity, only the RNC 606 and the RNS 607 are shown; however, the RAN 602 may include any number of RNCs and RNSs in addition to the RNC 606 and RNS 607. The RNC 606 is an apparatus responsible for, among other things, assigning, reconfiguring and releasing radio resources within the RNS 607. The RNC 606 may be interconnected to other RNCs (not shown) in the RAN 602 through various types of interfaces such as a direct physical connection, a virtual network, or the like, using any suitable transport network.

The geographic region covered by the RNS 607 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 608 are shown; however, the RNS 607 may include any number of wireless nodeBs. The nodeBs 608 provide wireless access points to a core network 604 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 610 are shown in communication with the nodeBs 608. The downlink (DL), also called the forward link, refers to the communication link from a nodeB to a UE, and the uplink (UL), also called the reverse link, refers to the communication link from a UE to a nodeB.

The core network 604, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 604 supports circuit-switched services with a mobile switching center (MSC) 612 and a gateway MSC (GMSC) 614. One or more RNCs, such as the RNC 606, may be connected to the MSC 612. The MSC 612 is an apparatus that controls call setup, call routing, and UE mobility functions. The MSC 612 also includes a visitor location register (VLR) (not shown) that contains subscriber-related information for the duration that a UE is in the coverage area of the MSC 612. The GMSC 614 provides a gateway through the MSC 612 for the UE 610 to access a circuit-switched network 616. The GMSC 614 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 614 queries the HLR to determine the UE's location and forwards the call to the particular MSC serving that location.

The core network 604 also supports packet-data services with a serving GPRS support node (SGSN) 618 and a gateway GPRS support node (GGSN) 620. GPRS, which stands for general packet radio service, is designed to provide packet-data services at speeds higher than those available with standard GSM circuit-switched data services. The GGSN 620 provides a connection for the RAN 602 to a packet-based network 622. The packet-based network 622 may be the Internet, a private data network, or some other suitable packet-based network. The primary function of the GGSN 620 is to provide the UEs 610 with packet-based network connectivity. Data packets are transferred between the GGSN 620 and the UEs 610 through the SGSN 618, which performs primarily the same functions in the packet-based domain as the MSC 612 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 608 and a UE 610, but divides uplink and downlink transmissions into different time slots in the carrier.

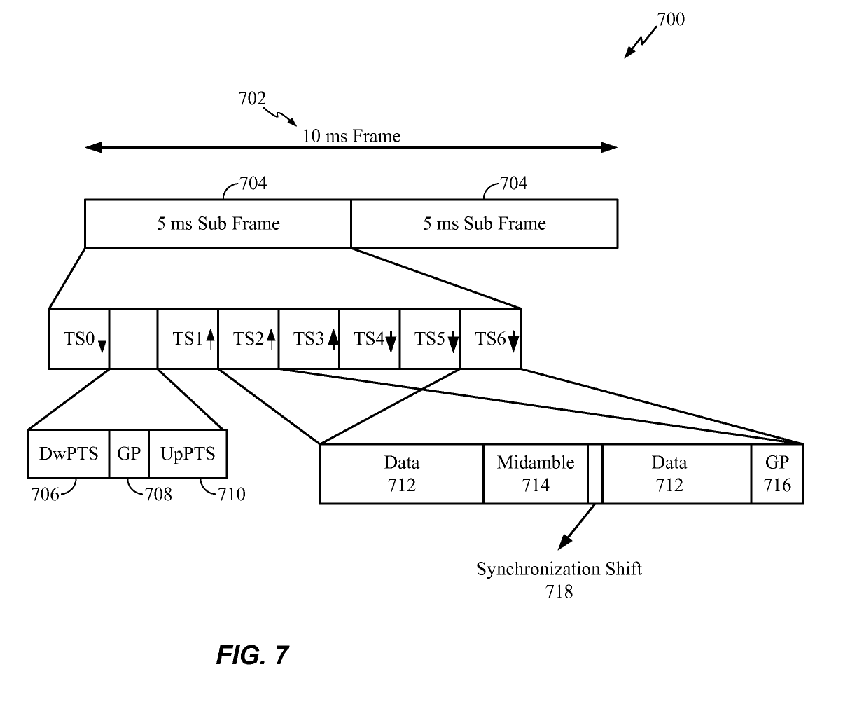

FIG. 7 shows a frame structure 700 for a TD-SCDMA carrier. The TD-SCDMA carrier, as illustrated, has a frame 702 that is 10 ms in length. The chip rate in TD-SCDMA is 1.28 Mcps. The frame 702 has two 5 ms subframes 704, and each of the subframes 704 includes seven time slots, TS0 through TS6. The first time slot, TSO, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 706, a guard period (GP) 708, and an uplink pilot time slot (UpPTS) 710 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 712 (each with a length of 352 chips) separated by a midamble 714 (with a length of 144 chips) and followed by a guard period (GP) 716 (with a length of 16 chips). The midamble 714 may be used for features, such as channel estimation, while the guard period 716 may be used to avoid inter-burst interference. Also transmitted in the data portion is some Layer 1 control information, including synchronization shift (SS) bits 718. Synchronization shift bits 718 only appear in the second part of the data portion. The synchronization shift bits 718 immediately following the midamble can indicate three cases: decrease shift, increase shift, or do nothing in the upload transmit timing. The positions of the synchronization shift bits 718 are not generally used during uplink communications.

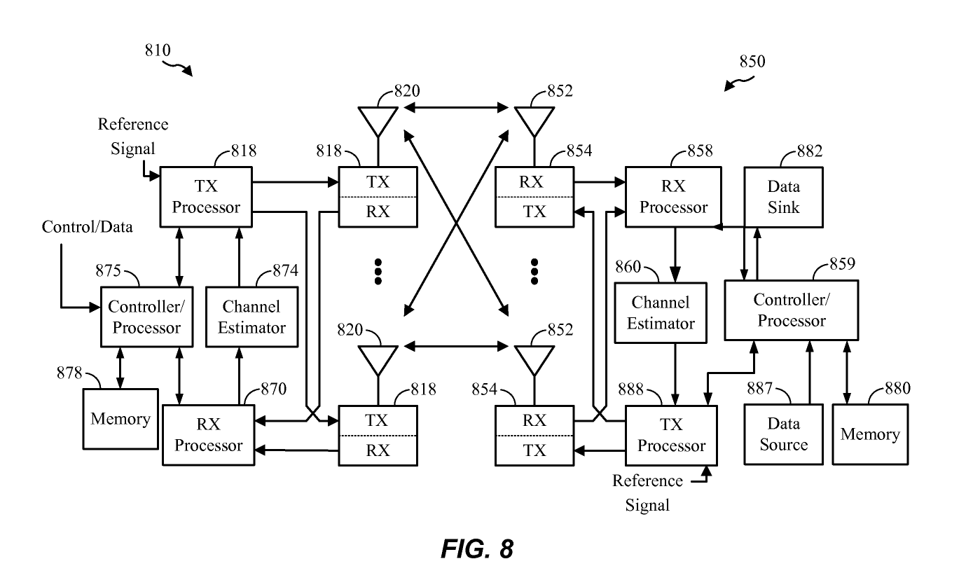

FIG. 8 is a block diagram of a base station 810 (such as a NodeB or eNodeB) in communication with a UE 850 in an access network. In the downlink, upper layer packets from the core network are provided to a controller/processor 875. The controller/processor 875 implements the functionality of the L2 layer. In the downlink, the controller/processor 875 provides header compression, ciphering, packet segmentation and reordering, multiplexing between logical and transport channels, and radio resource allocations to the UE 850 based on various priority metrics. The controller/processor 875 is also responsible for HARQ operations, retransmission of lost packets, and signaling to the UE 850.

The TX processor 873 implements various signal processing functions for the L1 layer (i.e., physical layer). The signal processing functions includes coding and interleaving to facilitate forward error correction (FEC) at the UE 850 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM stream is spatially precoded to produce multiple spatial streams. Channel estimates from a channel estimator 874 may be used to determine the coding and modulation scheme, as well as for spatial processing. The channel estimate may be derived from a reference signal and/or channel condition feedback transmitted by the UE 850. Each spatial stream is then provided to a different antenna 820 via a separate transmitter 818TX. Each transmitter 818TX modulates a radio frequency (RF) carrier with a respective spatial stream for transmission.

At the UE 850, each receiver 854RX receives a signal through its respective antenna 852. Each receiver 854RX recovers information modulated onto an RF carrier and provides the information to the receiver (RX) processor 858. The RX processor 858 implements various signal processing functions of the L1 layer. The RX processor 858 performs spatial processing on the information to recover any spatial streams destined for the UE 850. If multiple spatial streams are destined for the UE 850, they may be combined by the RX processor 858 into a single OFDM symbol stream. The RX processor 858 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 810. These soft decisions may be based on channel estimates computed by the channel estimator 860. The soft decisions are then decoded and deinterleaved to recover the data and control signals that were originally transmitted by the base station 810 on the physical channel. The data and control signals are then provided to the controller/processor 859.

The controller/processor 859 implements the L2 layer. The controller/processor 859 can be associated with a memory 880 that stores program codes and data. The memory 880 may be referred to as a computer-readable medium. In the uplink, the controller/processor 859 provides demultiplexing between transport and logical channels, packet reassembly, deciphering, header decompression, control signal processing to recover upper layer packets from the core network. The upper layer packets are then provided to a data sink 882, which represents all the protocol layers above the L2 layer. Various control signals may also be provided to the data sink 882 for L3 processing. The controller/processor 859 is also responsible for error detection using an acknowledgement (ACK) and/or negative acknowledgement (NACK) protocol to support HARQ operations.

In the uplink, a data source 887 is used to provide upper layer packets to the controller/processor 859. The data source 887 represents all protocol layers above the L2 layer. Similar to the functionality described in connection with the downlink transmission by the base station 810, the controller/processor 859 implements the L2 layer for the user plane and the control plane by providing header compression, ciphering, packet segmentation and reordering, and multiplexing between logical and transport channels based on radio resource allocations by the base station 810. The controller/processor 859 is also responsible for HARQ operations, retransmission of lost packets, and signaling to the base station 810.

Channel estimates base station by a channel estimator 860 from a reference signal or feedback transmitted by the base station 810 may be used by the TX processor 888 to select the appropriate coding and modulation schemes, and to facilitate spatial processing. The spatial streams generated by the TX processor 888 are provided to different antenna 852 via separate transmitters 854TX. Each transmitter 854TX modulates an RF carrier with a respective spatial stream for transmission.

The uplink transmission is processed at the base station 810 in a manner similar to that described in connection with the receiver function at the UE 850. Each receiver 818RX receives a signal through its respective antenna 820. Each receiver 818RX recovers information modulated onto an RF carrier and provides the information to a RX processor 870. The RX processor 870 may implement the L1 layer.

The controller/processor 875 implements the L2 layer. The controller/processor 875 can be associated with a memory 878 that stores program codes and data. The memory 878 may be referred to as a computer-readable medium. In the uplink, the controller/processor 875 provides demultiplexing between transport and logical channels, packet reassembly, deciphering, header decompression, control signal processing to recover upper layer packets from the UE 850. Upper layer packets from the controller/processor 875 may be provided to the core network. The controller/processor 875 is also responsible for error detection using an ACK and/or NACK protocol to support HARQ operations.

### Modifying Periodic Uplink Transmissions to Mitigate the Loss of Information Transmitted During a Tune Away Period

In some wireless systems, a user equipment (UE) may be specified to use multiple subscriber identity modules (SIMs). In one configuration, each SIM is specified for both data and voice services. In yet another configuration, one SIM may provide voice services and another SIM may provide data services.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique international mobile subscriber identity (IMSI) and service subscription information. Each SIM may be configured to operate in a particular radio access technology. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using a single radio frequency (RF) chain to transmit and receive communications. In one example, a multi-SIM device includes a first SIM dedicated to operate in first RAT and a second SIM dedicated to operate in a second RAT. In one illustrative example, the multi-SIM device includes a first SIM configured to operate in GSM (i.e., G subscription) and a second SIM configured to operate in TD-SCDMA (i.e., T subscription). When the T subscription is in the dedicated channel (DCH) state without voice traffic, the multi-SIM device supports a TD-SCDMA to GSM tune away with the least amount of interruption to the TD-SCDMA DCH operation. When the UE is in the TD-SCDMA dedicated channel, the UE periodically tunes away from TD-SCDMA, and tunes to GSM to monitor for pages. If the G subscription detects a page when the T to G tune away is active, the multi-SIM UE suspends all operations of the TD-SCDMA subscription and transitions to another RAT. If the other RAT subscription does not detect a page, the UE tunes back to TD-SCDMA and attempts to recover to the original operation of the TD-SCDMA subscription. The multi-SIM device may operate in other RATS known to those skilled in the art.

Aspects of the present disclosure are not limited to dual-SIM UEs that support dual subscriber identity module dual standby. Of course, aspects of the present disclosure are also contemplated for single SIM UEs or multiple SIM UEs that tune away from a first RAT to monitor a second RAT.

As an example, when a user equipment (UE) is in a connected mode for a first RAT, such as LTE, the UE may periodically tune away from the first RAT to monitor activity of a second RAT, such as GSM or TD-SCDMA. As an example, the activity performed by the second SIM/RAT/etc. may include monitoring for paging information of the second RAT, collecting a system information block (SIB) of the second RAT, and/or performing cell reselection for a second RAT. In one example, if a page is detected when the UE is tuned to the second RAT, the UE may suspend all operation of the first RAT and transition to the second RAT. When a page is not detected on the second RAT, the UE tunes back, or attempts to tune back, to the first RAT to recover the original operation of the first RAT. The connected mode RAT, such as the first RAT, may be referred to as a serving RAT and the other RATs may be referred to as non-serving RAT.

During the tune away gap, a base station of the first RAT is unaware that the UE has tuned away to the second RAT. Due to the lack of awareness, the base station of the first RAT may continue to send data to the UE. As a result, the data sent during the tune away period may not be received by the UE. In some cases, the data sent by the first RAT to the UE during the tune away period may include critical information such as radio resource control (RRC) connection release information, circuit-switched fallback (CSFB) paging information, and/or timing advance (TA) commands.

Communication errors, such as a dropped call, may occur when critical information is missed. For example, when the UE fails to receive the radio resource control (RRC) connection release information for the first RAT, the UE may attempt to recover the data call on the first RAT when the UE returns to the first RAT. The recovery attempt may increase the power usage of the UE, resulting in decreased battery performance. Additionally, a mobile terminated call to the UE may fail when the UE does not receive the circuit-switched fallback paging information. Further, when the UE does not receive the timing advance command, the timing advance timer may expire and the call to the UE may be dropped. Aspects of the present disclosure are directed to reducing the loss of critical information when a UE is tuned away from a first RAT to monitor a second RAT.

In one configuration, a base station of the first RAT detects discontinuous transmissions from a UE. That is, in this configuration, the base station performs uplink discontinuous transmission (DTX) detection to determine whether the UE is in a discontinuously transmitting mode. Specifically, the periodic uplink transmissions may be discontinued when the UE is tuned away from the first RAT. Therefore, the base station fails to receive periodically transmitted uplink signals from the UE. The periodically transmitted uplink signals may include a sounding reference signal (SRS), a channel quality indicator (CQI), a pre-coding matrix indicator (PMI) and/or a rank indicator (RI). The uplink signals may be transmitted via a physical uplink control channel (PUCCH).

In one configuration, when the base station determines that the UE is tuned away, the base station temporarily suspends transmission of critical information to the UE. Furthermore, the base station may resume transmission of the critical information when the UE tunes back to the base station and/or when the base station determines that the UE is in a continuous transmission state.

In another configuration, the UE may determine when a tune away period will occur. Based on the determination of a tune away period, the UE may determine whether to suspend one or more periodic uplink transmissions before the beginning of a tune away period. The determination may be based on timing. For example, the timing may is based on an amount of time (e.g., time difference) between a beginning of the tune away period and a periodic uplink transmission that is scheduled after the beginning of the tune away, a serving cell signal quality, and/or a quality of service (QoS) specified for the network. The beginning of a tune away period may sometimes be referred to as the tune away start time. Furthermore, the end of the tune away period may sometimes be referred to as the tune away end time.

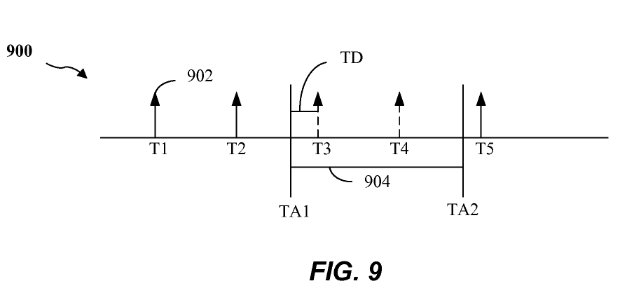

FIG. 9 illustrates an example of a timeline 900 for uplink transmissions 902 and a tune away period 904. As shown in FIG. 9, the uplink transmissions 902 may be periodically scheduled to occur at various times T1-T5. Furthermore, a tune away period 904 may be scheduled from a tune away start time TA1 to a tune away end time TA2. Additionally, as previously discussed, one or more uplink transmissions may be scheduled during the tune away period. For example, as shown in FIG. 9, the uplink transmissions 902 at a third time T3 and a fourth time T4 are scheduled during the tune away period 904. Still, the uplink transmissions 902 scheduled for the third time T3 and the fourth time T4 will not be transmitted because the UE will be tuned away from a serving RAT to a non-serving RAT.

As previously discussed, in one configuration, the UE determines whether to suspend one or more periodic uplink transmissions prior to a tune away period. The determination may be based on the timing of an uplink transmission that is scheduled during a tune away period, the signal quality of the serving cell, and/or a specified quality of service.

For the timing of the uplink transmission that is scheduled during a tune away period, the UE may determine an amount of time between a start of a tune away period and a transmission of the uplink transmission that is scheduled subsequent to a start time of a tune away period.

For example, as shown in FIG. 9, the uplink transmission 902 scheduled for time T3 is the uplink transmission that is scheduled subsequent to a start time of a tune away period 904. In this example, the UE determines a timing difference TD between an amount of time from the tune away start time TA1 and a scheduled time (T3) of the uplink transmission 902 that is scheduled subsequent to a start time of a tune away period 904.

In one configuration, when the timing difference between an amount of time from the tune away start time and a scheduled time of the uplink transmission is greater than a threshold, the UE suspends an uplink transmission. For example, based on the example shown in FIG. 9, if the timing difference TD is greater than a threshold, the UE suspends the uplink transmission 902 that is scheduled (T2) prior to a start time TA1 of a tune away period 904.

Furthermore, in the present configuration, when the timing difference between an amount of time from the tune away start time and scheduled time of the uplink transmission that is scheduled subsequent to a start time of a tune away period is less than a threshold, the UE suspends the first uplink transmission that occurs subsequent to the start time of the tune away period. For example, based on the example of FIG. 9, if the timing difference TD is less than a threshold, the UE does not suspend the scheduled uplink transmission 902 at time T2.

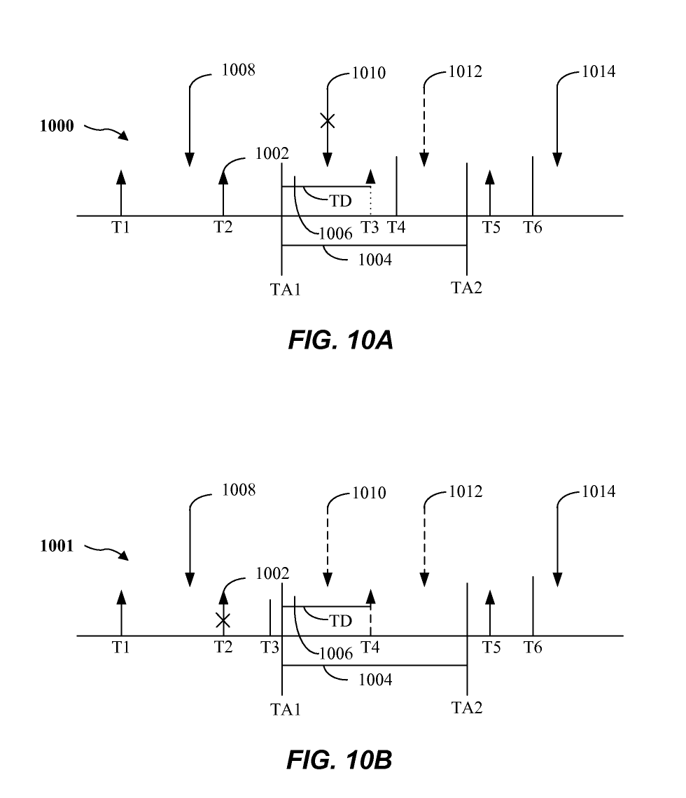

In some cases, if the timing difference is greater than a threshold, the UE may not receive critical information transmitted by the base station. FIG. 10A illustrates an example of a timeline 1000 for uplink transmissions 1002 and a tune away period 1004. For example, as shown in FIG. 10A, the timing difference TD is greater than a threshold 1006. In this example, the UE receives a first critical information transmission 1008 prior to the tune away period 1004. Furthermore, the base station receives uplink transmissions 1002 at a first time T1 and a second time T2.

Additionally, as shown in FIG. 10A, the UE begins a tune away period 1004 at the tune away start time TA1. In this example, the base station is unaware that the UE has entered a tune away period 1004. Therefore, the base station transmits second critical information 1010 and the UE does not receive the second critical information transmission 1010 because the UE has tuned away. Furthermore, in this example, the base station expects to receive a periodic uplink transmission 1002 at a third time T3. However, because the UE is tuned away, the UE does not transmit the periodic uplink transmission 1002 at the third time T3. Thus, at a fourth time T4, the base station may determine that the UE is in a discontinuous transmission state because the base station failed to receive the periodic uplink transmission 1002 at the third time T3. Accordingly, after determining that the UE is in a discontinuous transmission state, the base station may suspend transmissions of critical information. For example, as shown in FIG. 10A, the base station may suspend a third critical information transmission 1012.

Furthermore, as shown in FIG. 10A, after a tune away end time TA2, the UE may resume the periodic uplink transmissions 1002. Specifically, in the example of FIG. 10A, at a fifth time T5, the UE transmits an uplink transmission 1002. Additionally, at a sixth time T6, the base station may determine that the UE is no longer in a discontinuous reception stage, thus, the base station may resume the transmission of critical information. For example, the base station may transmit fourth critical information 1014 after determining, at a sixth time T6, that the UE is no longer in a discontinuous reception stage.

Thus, in one configuration, if the timing difference is greater than a threshold, the UE suspends the transmission of the uplink transmission scheduled prior to the start time of the tune away period. FIG. 10B illustrates an example of a timeline 1001 for uplink transmissions 1002 and a tune away period 1004. As an example, as shown in FIG. 10B, the timing difference TD is greater than a threshold 1006. Furthermore, in this example, the uplink transmission 1002 scheduled at the second time T2 is the uplink transmission that is scheduled prior to the tune away period 1004. Therefore, in this example, the UE suspends the transmission of the uplink transmission 1002 scheduled at the second time T2 because the timing difference TD is greater than a threshold 1006.

Furthermore, in the present example, based on the uplink transmission 1002 at the first time T1, the base station expects to receive an uplink transmission at the second time T2. Still, in this example, because the timing difference TD is greater than a threshold 1006, the UE suspended the transmission of the uplink transmission 1002 scheduled at the second time T2. Therefore, because the base station fails to receive the uplink transmission 1002 scheduled at the second time T2, the base station determines, at a third time T3, that the UE is in a discontinuous transmission state. Thus, the base station suspends the transmission of critical information in response to determining that the UE is in a discontinuous transmission state.

As shown in FIG. 10B, the base station suspends the transmission of second critical information 1010 and third critical information 1012. Moreover, the suspension of the transmission of second critical information 1010 and third critical information 1012 mitigates the failure to receive critical information transmitted during the tune away period 1004. Furthermore, as shown in FIG. 10B, after a tune away end time TA2, the UE may resume the periodic uplink transmissions 1002. Specifically, in the example of FIG. 10B, at a fifth time T5, the UE transmits an uplink transmission 1002. Additionally, in response to receiving the uplink transmissions 1002 transmitted at the fifth time T5, the base station may determine at a sixth time T6, that the UE is no longer in a discontinuous reception stage. Thus, the base station may resume the transmission of critical information. For example, the base station may transmit fourth critical information 1014 after determining, at the sixth time T6, that the UE is no longer in a discontinuous reception stage.

FIG. 10B illustrates that the UE suspends one uplink transmission 1002 that is prior to the start time TA1 of the tune away period 1004. It should be noted that aspects of the present disclosure are not limited to suspending only one uplink transmission. In one configuration, the UE suspends more than one uplink transmission prior to the start time of a tune away period.

In some cases, if the timing difference is less than a threshold, the base station may determine that the UE is in a discontinuous transmission state prior to the transmission of the critical information. Thus, in this example, the UE may maintain the uplink transmission scheduled prior to the start time of the tune away period because the UE may not miss the transmission of critical information.

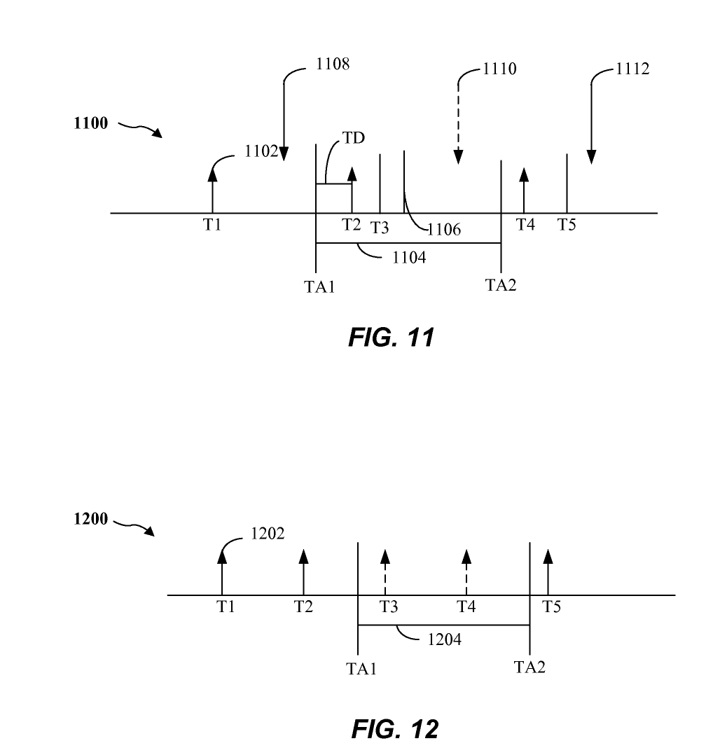

FIG. 11 illustrates an example of a timeline 1100 for uplink transmissions 1102 and a tune away period 1104. For example, as shown in FIG. 11, the timing difference TD is less than a threshold 1106. In this example, the UE receives a first critical information transmission 1108 prior to the tune away period 1104. Furthermore, the base station receives an uplink transmission 1102 at a first time T1.

Additionally, as shown in FIG. 11, the UE begins a tune away period 1104 at the tune away start time TA1. In this example, the base station is unaware that the UE has entered a tune away period 1104. Thus, in this example, the base station expects to receive a periodic uplink transmission 1102 at a second time T2. However, because the UE is tuned away, the UE does not transmit the periodic uplink transmission 1102 at the second time T2. Thus, at a third time T3, the base station may determine that the UE is in a discontinuous transmission state because the base station failed to receive the periodic uplink transmission 1102 at the third time T3. Accordingly, after determining that the UE is in a discontinuous transmission state, the base station may suspend transmissions of critical information. For example, as shown in FIG. 11, the base station may suspend a second critical information transmission 1110.

Still, in this example, the scheduled transmission time (T2) of the uplink transmission 1102 is prior to the transmission of the second critical information 1110. Therefore, in this example, the UE does not miss the transmission of critical information because the timing difference is less than a threshold.

Furthermore, as shown in FIG. 11, after a tune away end time TA2, the UE may resume the periodic uplink transmissions 1102. Specifically, in the example of FIG. 11, at a fourth time T4, the UE transmits an uplink transmission 1102. Additionally, at a fifth time T5, the base station may determine that the UE is no longer in a discontinuous reception stage. Thus, the base station may resume the transmission of critical information. For example, the base station may transmit third critical information 1112 after determining, at a fifth time T5, that the UE is no longer in a discontinuous reception stage.

Thus, in one configuration, if the timing difference between the start of a tune away period and a subsequent periodic uplink transmission is less than a threshold, the UE does not suspend the transmission of a periodic uplink transmission that is scheduled prior to the tune away period.

It should be noted that the timing and transmission examples of FIGS. 9, 10A, 10B, 11, and 12 are not to scale and are only provided for illustrative purposes. Additionally, in aspects of the present disclosure the periodic uplink transmission may sometimes be referred to as an uplink transmission or a scheduled uplink transmission.

Additionally, or alternatively, in one configuration, the UE determines whether to suspend one or more scheduled uplink transmissions based on quality of service requirements and/or serving cell signal quality.

According to an aspect of the present disclosure, if the signal quality of the serving cell is greater than a threshold, the UE may suspend the scheduled transmission that is prior to a start time of a tune away period. Furthermore, in this configuration, if the signal quality of the serving cell is less than a threshold, the UE may suspend two or more scheduled transmissions that are prior to a start time of a tune away period.

FIG. 12 illustrates an example of a timeline 1200 for periodic uplink transmissions 1202 from a UE. As shown in FIG. 12, the uplink transmissions 1202 may be scheduled to transmit at a first time T1, a second time T2, a third time T3, a fourth time T4, and a fifth time T5. In this example, the uplink transmissions 1202 scheduled during a tune away period 1204 are not transmitted because the UE is tuned away. The tune away period 1204 begins at a tune away start time TA1 and ends at a tune away end time TA2.

As previously discussed, the base station may determine that a UE is in a discontinuous transmission state when the UE does not receive a periodic uplink transmission from the UE. Still, the base station may transmit critical information to the UE when the UE is tuned away. Therefore, it is desirable for the base station to determine that the UE is in a discontinuous reception state prior to the UE entering the tune away period or prior to the base station transmitting critical information when the UE is in the tune away period.

As previously discussed, if the signal quality of the serving cell is less than a threshold, the UE may suspend a plurality of scheduled transmissions that are prior to a start time of a tune away period. Thus, in this example, when the signal quality of the serving cell is less than a threshold, the UE may suspend the plurality of uplink transmissions 1202 scheduled for the first time period T1 and the second time period T2. Of course, the UE is not limited to only suspending the uplink transmissions 1202 scheduled for the first time period T1 and the second time period T2, in this example, the UE may also suspend other uplink transmissions 1202 (not shown) scheduled prior to the first time period T1.

Alternatively, if the signal quality of the serving cell is greater than a threshold, the UE may suspend the scheduled transmission that is prior to a start time of a tune away period. Thus, in this example, when the signal quality of the serving cell is greater than a threshold, the UE may suspend the uplink transmissions 1202 scheduled for the second time period T2.

Furthermore, in another configuration, if the quality of service specified by the network is less than a threshold, the UE may suspend two or more scheduled transmissions that are prior to a tune away period. Thus, in this example, when the quality of service specified by the network is less than a threshold, the UE may suspend the uplink transmissions 1202 scheduled for the first time period Ti and the second time period T2. Of course, the UE is not limited to only suspending the uplink transmissions 1202 scheduled for the first time period T1 and the second time period T2, in this example, the UE may also suspend other uplink transmissions 1202 (not shown) scheduled prior to the first time period T1.

Alternatively, if the quality of service specified by the network is greater than a threshold, the UE may suspend the scheduled transmission that is prior to a start time of a tune away period. Thus, in this example, when the quality of service specified by the network is greater than a threshold, the UE may suspend the uplink transmissions 1202 scheduled for the second time period T2.

When the quality of service specified by the network is greater than a threshold and/or the signal quality of the serving cell is greater than a threshold, the network has improved reliability. Therefore, to maintain network reliability, the UE reduces the number of uplink transmissions that are suspended. For example, the UE may only suspend one uplink transmission. Of course, the UE may suspend more uplink transmissions if network reliability is not reduced as a result of the suspension of multiple uplink transmissions.

Additionally, when the quality of service specified by the network is less than a threshold and/or the signal quality of the serving cell is less than a threshold, the network reliability may be reduced. Therefore, the UE may suspend multiple uplink transmissions.

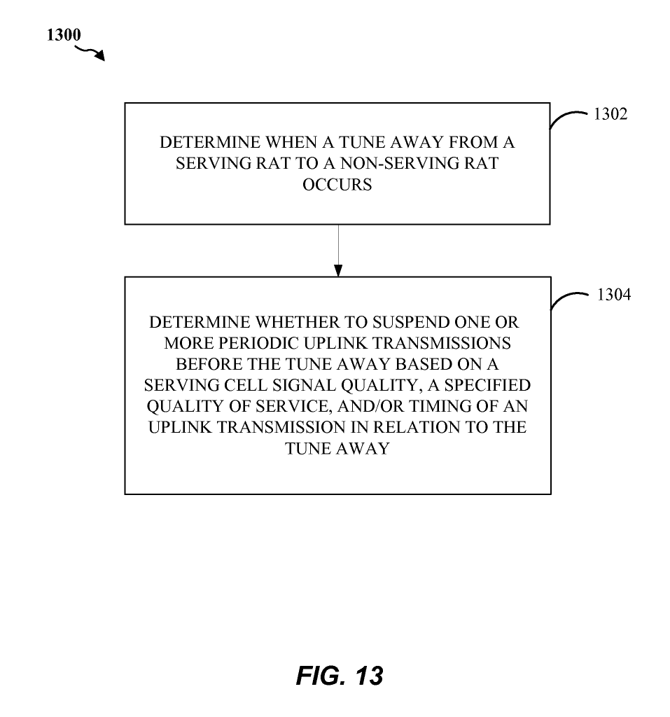

FIG. 13 illustrates a method 1300 for wireless communication. In block 1302, a UE determines when a tune away from a serving RAT to a non-serving RAT occurs. Furthermore, the UE determines whether to suspend at least one or more periodic uplink transmissions before the tune away based on a serving cell signal quality, a specified quality of service, and/or a timing of an uplink transmission in relation to the tune away in block 1304.

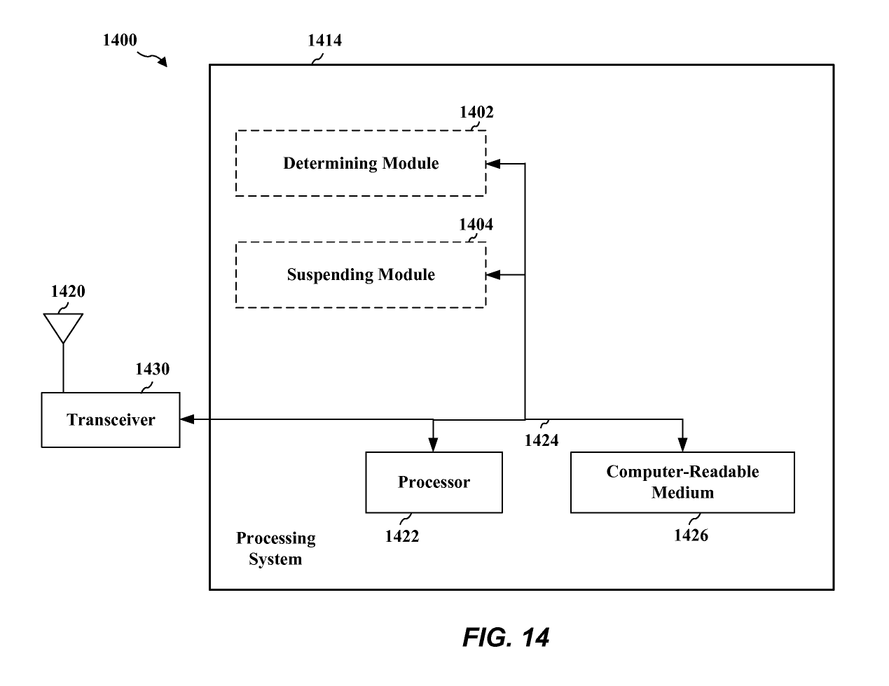

FIG. 14 is a diagram illustrating an example of a hardware implementation for an apparatus 1400 employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1422 the modules 1402, 1404 and the computer-readable medium 1426. The bus 1424 may also link various other circuits such as timing sources, peripherals, voltage regulators, and power management circuits, which are well known in the art, and therefore, will not be described any further.

The apparatus includes a processing system 1414 coupled to a transceiver 1430. The transceiver 1430 is coupled to one or more antennas 1420. The transceiver 1430 enables communicating with various other apparatus over a transmission medium. The processing system 1414 includes a processor 1422 coupled to a computer-readable medium 1426. The processor 1422 is responsible for general processing, including the execution of software stored on the computer-readable medium 1426. The software, when executed by the processor 1422, causes the processing system 1414 to perform the various functions described for any particular apparatus. The computer-readable medium 1426 may also be used for storing data that is manipulated by the processor 1422 when executing software.

The processing system 1414 includes a determining module 1402 that determines when a tune away from a serving RAT to a non-serving RAT occurs. The determining module 1402 may also determines whether to suspend one or more periodic uplink transmissions before the tune away based on a serving cell signal quality, a specified quality of service, and/or a timing of an uplink transmission in relation to the tune away. The processing system 1414 also includes a suspending module 1404 for suspending one or more periodic uplink transmissions that are scheduled to occur prior to a start time of a tune away period. The modules may be software modules running in the processor 1422, resident/stored in the computer-readable medium 1426, one or more hardware modules coupled to the processor 1422, or some combination thereof. The processing system 1414 may be a component of the UE 850 memory 880 and/or the controller/processor 859.

In one configuration, the UE 850 is configured for wireless communication including means for determining. In one aspect, the determining means may be the controller/processor 859, transmit processor 888, memory 880, and/or determining module 1402 configured to perform the functions recited by the determining means. The UE 850 is also configured to include a means for suspending. In one aspect, the suspending means may be the transmit processor 888, controller/processor 859, and/or suspending module 1404 configured to perform the functions recited by the suspending means. In another aspect, the aforementioned means may be any module or any apparatus configured to perform the functions recited by the aforementioned means.

Several aspects of a telecommunications system has been presented with reference to GSM, TD-SCDMA and LTE systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing Long Term Evolution (LTE) (in FDD, TDD, or both modes), LTE-advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a user terminal In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed:

1. A method of wireless communication, comprising:
determining, at a user equipment (UE), when a tune away from a serving radio access technology (RAT) to a non-serving RAT occurs to perform measurements of the non-serving RAT, the UE tuning back to the serving RAT after the tune away; and
determining, at the UE, whether to suspend at least one periodic uplink transmission to the serving RAT before the tune away to enable detection of the tune away prior to the serving RAT performing a downlink transmission during the tune away, the determination to suspend being based at least in part on at least one of a serving cell signal quality, a specified quality of service, timing of an uplink transmission in relation to the tune away, or any combination thereof.

2. The method of claim 1, in which the timing is a time difference between a start time of the tune away and a scheduled time for the uplink transmission that is subsequent to the start time.

3. The method of claim 2, in which the uplink transmission scheduled immediately prior to the start time is suspended when the time difference is greater than a threshold.

4. The method of claim 1, in which the uplink transmission scheduled immediately prior to a start time of the tune away is suspended when at least one of the serving cell signal quality is greater than a threshold, a specified quality of service is greater than a threshold, or combination thereof.

5. The method of claim 1, in which a plurality of uplink transmissions scheduled prior to a start time of the tune away are suspended when at least one of the serving cell signal quality is less than a threshold, a specified quality of service is less than a threshold, or combination thereof.

6. The method of claim 1, in which the at least one periodic uplink transmission comprises at least one of a sounding reference signal (SRS), a channel quality indicator (CQI), a pre-coding matrix indicator (PMI), a rank indicator (RI), or any of combination thereof.

7. An apparatus for wireless communication, the apparatus comprising:
means for determining, at a user equipment (UE), when a tune away from a serving radio access technology (RAT) to a non-serving RAT occurs to perform measurements of the non-serving RAT, the UE tuning back to the serving RAT after the tune away; and
means for determining, at the UE, whether to suspend at least one periodic uplink transmission to the serving RAT before the tune away to enable detection of the tune away prior to the serving RAT performing a downlink transmission during the tune away, the determination to suspend being based at least in part on at least one of a serving cell signal quality, a specified quality of service, timing of an uplink transmission in relation to the tune away, or any combination thereof.

8. The apparatus of claim 7, in which the timing is a time difference between a start time of the tune away and a time scheduled for the uplink transmission that is subsequent to the start time.

9. The apparatus of claim 8, in which the uplink transmission scheduled immediately prior to the start time is suspended when the time difference is greater than a threshold.

10. The apparatus of claim 7, in which the uplink transmission scheduled immediately prior to a start time of the tune away is suspended when at least one of the serving cell signal quality is greater than a threshold, a specified quality of service is greater than a threshold, or combination thereof.

11. The apparatus of claim 7, in which a plurality of uplink transmissions scheduled prior to a start time of the tune away are suspended when at least one of the serving cell signal quality is less than a threshold, a specified quality of service is less than a threshold, or combination thereof.

12. The apparatus of claim 7, in which the at least one periodic uplink transmission comprises at least one of a sounding reference signal (SRS), a channel quality indicator (CQI), a pre-coding matrix indicator (PMI), a rank indicator (RI), or any combination thereof.

13. A user equipment (UE) for wireless communication, the apparatus comprising:
a memory module; and
at least one processor coupled to the memory module, the at least one processor configured:
to determine when a tune away from a serving radio access technology (RAT) to a non-serving RAT occurs to perform measurements of the non-serving RAT, the UE tuning back to the serving RAT after the tune away; and
to determine whether to suspend at least one periodic uplink transmission to the serving RAT before the tune away to enable detection of the tune away prior to the serving RAT performing a downlink transmission during the tune away, the determination to suspend being based at least in part on at least one of a serving cell signal quality, a specified quality of service, timing of an uplink transmission in relation to the tune away, or any combination thereof.

14. The UE of claim 13, in which the timing is a time difference between a start time of the tune away and a time scheduled for the uplink transmission that is subsequent to the start time.

15. The UE of claim 14, in which the uplink transmission scheduled immediately prior to the start time is suspended when the time difference is greater than a threshold.

16. The UE of claim 13, in which the uplink transmission scheduled immediately prior to a start time of the tune away is suspended when at least one of the serving cell signal quality is greater than a threshold, a specified quality of service is greater than a threshold, or combination thereof.

17. The UE of claim 13, in which a plurality of uplink transmissions scheduled prior to a start time of the tune away are suspended when at least one of the serving cell signal quality is less than a threshold, a specified quality of service is less than a threshold, or combination thereof.

18. The UE of claim 13, in which the at least one periodic uplink transmission comprises at least one of a sounding reference signal (SRS), a channel quality indicator (CQI), a pre-coding matrix indicator (PMI), a rank indicator (RI), or any combination thereof

19. A non-transitory computer-readable medium having program code recorded thereon for wireless communications, the program code being executed by a processor and comprising:
program code to determine, at a user equipment (UE), when a tune away from a serving radio access technology (RAT) to a non-serving RAT occurs to perform measurements of the non-serving RAT, the UE tuning back to the serving RAT after the tune away; and
program code to determine, at the UE, whether to suspend at least one periodic uplink transmission to the serving RAT before the tune away to enable detection of the tune away prior to the serving RAT performing a downlink transmission during the tune away, the determination to suspend being based at least in part on at least one of a serving cell signal quality, a specified quality of service, timing of an uplink transmission in relation to the tune away, or any combination thereof.

20. The non-transitory computer-readable medium of claim 19, in which the timing is a time difference between a start time of the tune away and a time scheduled for the uplink transmission that is subsequent to the start time.

21. The non-transitory computer-readable medium of claim 20, in which the uplink transmission scheduled immediately prior to the start time is suspended when the time difference is greater than a threshold.

22. The non-transitory computer-readable medium of claim 19, in which the uplink transmission scheduled immediately prior to a start time of the tune away is suspended when at least one of the serving cell signal quality is greater than a threshold, a specified quality of service is greater than a threshold, or combination thereof.

23. The non-transitory computer-readable medium of claim 19, in which a plurality of uplink transmissions scheduled prior to a start time of the tune away are suspended when at least one of the serving cell signal quality is less than a threshold, a specified quality of service is less than a threshold, or combination thereof.

24. The non-transitory computer-readable medium of claim 19, in which the at least one periodic uplink transmission comprises at least one of a sounding reference signal (SRS), a channel quality indicator (CQI), a pre-coding matrix indicator (PMI), a rank indicator (RI), or any combination thereof.
